(19) United States
(12) Patent Application Publication
(10) Pub. No.: US 2004/0090688 A1
(43) Pub. Date: May 13, 2004

(54) Panorama mirror set for automobiles

(76) Inventor: Lloyd Clermont Mostrom, Arlington, VA (US)

Correspondence Address: Lloyd C. Mostrom, 910 North Montana Street, Arlington, VA, 22205-1622, US

(21) Appl. No.: 10/441,160

(22) Filed: May 20, 2003

Related U.S. Application Data
(60) Provisional application No. 60/391,613, filed on Jun. 27, 2002.

(51) Int. Cl. G02B 5/08; G02B 7/182

(52) U.S. Cl. 359/850

(57) ABSTRACT

The Panorama Mirror Set consists of several individual mirrors attached to a frame which may replace the present rear view mirror or the frame may be adapted to grip the present rear view mirror and support individual mirrors to each side of the installed rear view mirror. These individual mirrors will each be adjustable to reflect a given sector of the sides and rear of the automobile in which installed. The mountings may be such that each mirror has an adjustable mounting on a fixed frame, a fixed mounting on a hinged frame frame or the mirrors may be pre-adjusted on a fixed frame to reflect the sector images for easy viewing by the driver without interrupting the drivers forward view. The key criterion is that the driver can get an instantious image view of any automobile or other obstruction to the sides or rear of the automobile without interrupting his/herr forward view.

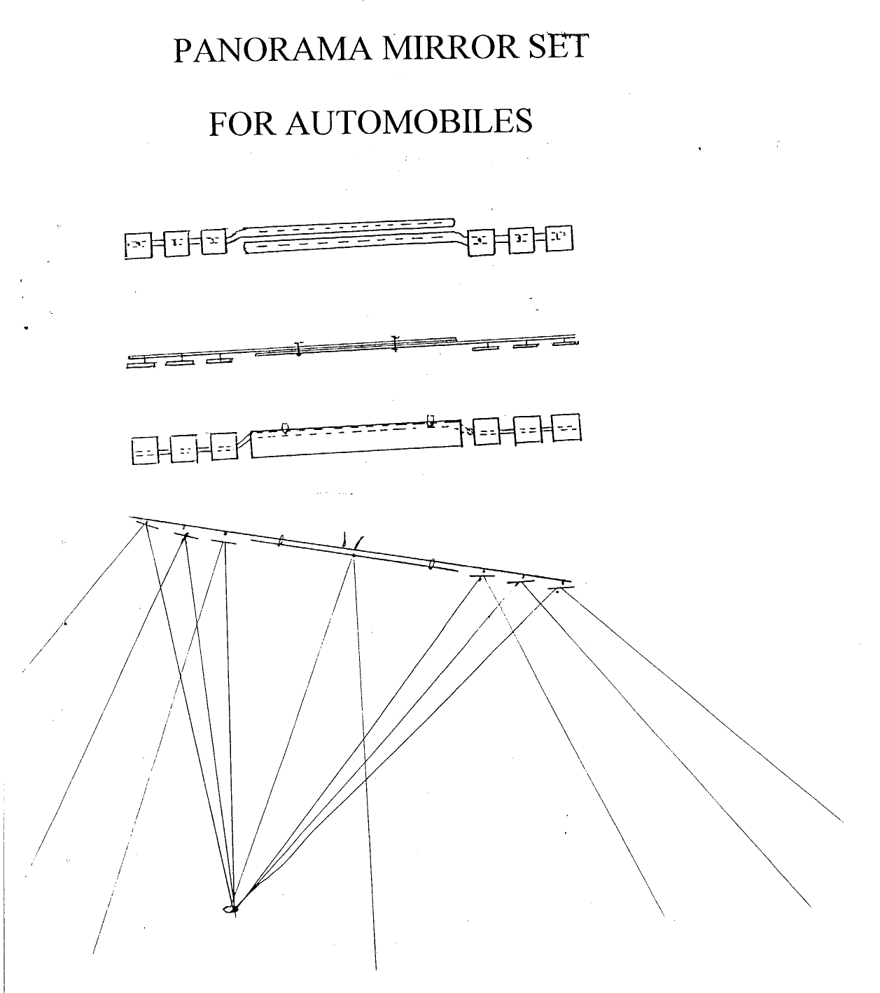

### CROSS REFERENCE TO RELATED APPLICATION

Provisional application submitted Jun. 27, 2002

### STATEMENT REGARDING FEDERALLY SPONSORED RESEARCH

Not applicable

### REFERENCE TO MICROFICHE APPENDIX

Not applicable

### BACKGROUND OF THE INVENTION

This invention is in response to the continued frequency of automobile accidents due to the ‘blind spots’ present in the current rear view mirror installed in automobiles and the distraction caused by the need for the driver to turn his/her head to look over the left or right shoulder to look for any approaching vehicle or other obstruction in those areas or alternately, failing to look for any vehicles approaching in those ‘blind spot’ areas. The ‘patch on enlargement mirrors’ presently available tend to distort the distance of the image to suggest that the second vehicle is more distant than it really is, thus giving a false sense of security.

### BRIEF SUMMARY OF THE INVENTION

This invention consists of one or more flat mirrors mounted on each side of the basic rear view mirror, each adjusted at a different angle to provide a true view of the sector to the rear or side for which adjusted. Thus, providing the driver a convenient image of any vehicle present in the sectors covered by these auxiliary mirrors but not covered by the rear view mirror presently installed in the automobile. With the location of these mirrors right in front of the driver, there is no need for the driver to be distracted by turning his/her head to see if there are any vehicles or other obstructions in those sectors.

### BRIEF DESCRIPTION OF THE INVENTION

The assembly consists of a simple two bar frame, the inner sections of which are slotted to permit adjustment to be fitted and clipped onto any currently installed automobile rear view mirror and the outer sections of which are each fitted with one or more mountings to support flat mirrors which are thus adjustable to cover designated sectors to the rear and sides of the automobile not covered by the original rear view mirror installed in the automobile

### DETAILED DESCRIPTION OF THE INVENTION

This assembly consists of two mating bars which are slotted on the inner sect ions to permit length adjustment and with spring clips to attach these bars to the top of the present rear view mirror of the automobile. The sections of these bars are fitted with one or more mountings adjustable both horizontally and vertically to which are attached flat surface mirrors of a size compatible with the installed rear view mirror. These auxiliary mirrors may be adjusted to reflect the desired rear and side sectors not effectively covered with the basic rear view mirror. The mating bars are configured so that inner sections can be clipped to the top of the installed rear view mirror and the outer sections support the auxiliary mirrors at a level compatible with the level of the original rear view mirror and easily observable by the driver. In future designs the rear view mirror support may be modified to support the side mirrors with adjustable supports to reflect images of objects present in the selected rear and side sectors.

### SUMMARY OF THE INVENTION

The Panorama Mirror Set for Automobiles is a simple assembly of mirrors readily attachable to, or replace, the conventional rear view mirror of the automobile to provide the driver with clear view images of any approaching vehicle or other obstruction in the several sectors of the rear and sides of the automobile not readily visible in the conventional rear view mirror. These images are visible at the same convenient eye level as the originally installed rear view mirror for a full panoramic view of the rear and sides of the automobile without the need of the driver to divert attention from the front to turn the head to look over the shoulder for any approaching vehicles or other obstruction. This assembly can be readily incorporated into the design of the originally installed rear view mirror assembly of the automobile which assembly is part of this invention.

I claim that the Panorama Mirror Set will:

1. Reduce the number of automobile accidents

2. Permit the driver of an automobile to pay full attention to the area in front

3. Reduce the amount of time that the driver of an automobile interrupts his/her forward vision to look for vehicles to the side or approaching from the rear

4. Permit the driver to see a mirror image of any vehicle or other obstruction to the side or approaching from the rear without looking over his/her shoulder thus interrupting his/her view to the front.

5. Relieve the driver's anxiety as to whether or not there are any approaching vehicles in the blind areas of the present rear view mirrors.
